(19) United States
(12) Patent Application Publication
(10) Pub. No.: US 2023/0278559 A1
(43) Pub. Date: Sep. 7, 2023

(54) METHOD AND APPARATUS FOR CONTROLLING VEHICLE, STORAGE MEDIUM, AND VEHICLE

(71) Applicant: BYD COMPANY LIMITED, Shenzhen (CN)

(72) Inventors: Weihua LIU, Shenzhen (CN); Kaikuo ZHUO, Shenzhen (CN); Chujun CHEN, Shenzhen (CN); Ruixing TANG, Shenzhen (CN); Zhili WU, Shenzhen (CN)

(21) Appl. No.: 18/144,753

(22) Filed: May 8, 2023

Related U.S. Application Data
(63) Continuation of application No. PCT/CN2021/131706, filed on Nov. 19, 2021.

(30) Foreign Application Priority Data
Nov. 20, 2020 (CN) 202011312258.7

(51) Int. Cl. B60W 30/16; B60W 30/14; B60W 30/09; B60W 40/105; B60W 40/107; B60W 10/18

(52) U.S. Cl. CPC B60W 30/16; B60W 10/18; B60W 30/09; B60W 30/143; B60W 40/105; B60W 40/107; B60W 2520/105; B60W 2554/802

(57) ABSTRACT

A method for controlling a vehicle, includes: acquiring current first vehicle state information of a first vehicle; determining a target vehicle distance according to the current first vehicle state information, where the target vehicle distance includes an inter-vehicle distance between the first vehicle and a second vehicle to enable synchronous control of the first vehicle and the second vehicle; determining a first target operating condition corresponding to the first vehicle according to the target vehicle distance and the current first vehicle state information; and receiving second vehicle operation information transmitted by the second vehicle, and adjusting the inter-vehicle distance to the target vehicle distance by controlling an operation of the first vehicle according to the first target operating condition and the second vehicle operation information.

### CROSS-REFERENCE TO RELATED APPLICATIONS

This application is a Continuation Application of International Patent Application No. PCT/CN2021/131706, filed on Nov. 19, 2021, which is based on and claims priority to and benefits of Chinese Patent Application No. 202011312258.7, filed on Nov. 20, 2020. The entire content of all of the above-referenced applications is incorporated herein by reference.

### FIELD

The present disclosure relates to the field of vehicle control, and more specifically, to a method and an apparatus for controlling a vehicle, a storage medium, and an electronic device.

### BACKGROUND

In the related art, a speed and a distance of a vehicle relative to a preceding vehicle may be measured through a millimeter-wave radar or a related sensor during implementation of the adaptive cruise control (ACC) following technique, and the vehicle may be accordingly controlled to perform operations such as acceleration and deceleration, thereby realizing the ACC of the vehicle. However, the existing ACC following technique has relatively poor control precision, and therefore cannot finely control a rear vehicle.

### SUMMARY

The present disclosure provides a method and an apparatus for controlling a vehicle, a storage medium, and a vehicle.

According to a first aspect, a method for controlling a vehicle is provided, including: acquiring current first vehicle state information of a first vehicle; determining a target vehicle distance according to the current first vehicle state information, where the target vehicle distance includes an inter-vehicle distance between the first vehicle and a second vehicle to enable synchronous control of the first vehicle and the second vehicle; determining a first target operating condition corresponding to the first vehicle according to the target vehicle distance and the current first vehicle state information; and receiving second vehicle operation information transmitted by the second vehicle, and adjusting the inter-vehicle distance to the target vehicle distance by controlling an operation of the first vehicle according to the first target operating condition and the second vehicle operation information.

According to a second aspect, an apparatus for controlling a vehicle is provided, including: a memory storing a computer program; and a processor, configured to execute the computer program to implement the steps of the method according to the first aspect of the present disclosure.

According to a third aspect, a non-transitory computer-readable storage medium is provided, a computer program stored in the medium. When the computer program is executed by a processor, causes the processor to implement the steps of the method according to the first aspect of the present disclosure.

According to a fourth aspect, a vehicle is provided, including the apparatus for controlling a vehicle according to the second aspect of the present disclosure.

Other features and advantages of the present disclosure will be described in detail in the following implementations.

### BRIEF DESCRIPTION OF THE DRAWINGS

The accompanying drawings provides further understanding of the present disclosure and constitute a part of this specification. The accompanying drawings and the specific implementations below are used together for explaining the present disclosure rather than constituting a limitation to the present disclosure. In the accompanying drawings:

FIG. 1 is a structural block diagram of a vehicle according to an embodiment.

FIG. 2 is a flowchart of a first vehicle control method according to an embodiment.

FIG. 3 is a flowchart of a second vehicle control method according to an embodiment.

FIG. 4 is a block diagram of a vehicle control apparatus according to an embodiment.

FIG. 5 is a structural block diagram of a vehicle according to an embodiment.

### DETAILED DESCRIPTION

Specific implementations of the present disclosure are described in detail below with reference to the accompanying drawings. It should be understood that the specific implementations described herein are merely used to describe and explain the present disclosure, but do not limit the present disclosure.

In the descriptions below, the terms “first” and “second” are used only to distinguish the purpose of the descriptions and are not to be understood as indicating or implying relative importance, nor as indicating or implying order.

First, an application scenario of the present disclosure is described. The present disclosure may be applied to a scenario of synchronous control of coupled vehicles, especially a scenario of synchronous control of coupled vehicles of the rail transit. In the related art, during implementation of the vehicle adaptive cruise control (ACC) following technique, a speed and a distance of a vehicle relative to a preceding vehicle may be measured through a millimeter-wave radar or a related sensor, to control the vehicle to perform operations such as acceleration and deceleration, thereby realizing the ACC of the vehicle. However, the existing ACC following technique has a relatively poor control precision, and therefore cannot finely control a rear vehicle.

In order to resolve the foregoing problem, the present disclosure provides a method and an apparatus for controlling a vehicle, a storage medium, and a vehicle. Current vehicle state information of a first vehicle (e.g., current first vehicle state information) may be acquired. The first vehicle state information may include a current position of the first vehicle, a communication period between the first vehicle and the second vehicle, an actual inter-vehicle distance between the first vehicle and the second vehicle, and the like. Then, a target vehicle distance between the first vehicle and the second vehicle that is to be maintained during the synchronous control of the first vehicle and the second vehicle is determined according to the first vehicle state information, and a target operating condition corresponding to the first vehicle (e.g., the first target operating condition) is determined according to the target vehicle distance and the first vehicle state information. The first vehicle may further receive vehicle operation information transmitted by the second vehicle (e.g., second vehicle operation information), to control the operation of the first vehicle according to the first target operating condition and the vehicle operation information of the second vehicle, and ensure that the first vehicle keeps a desirable stable distance from the second vehicle, that is, the target vehicle distance, during the operation under the current target operating condition, thereby improving the precision of vehicle synchronous control.

Embodiments of the present disclosure are described in detail below with reference to the accompanying drawings.

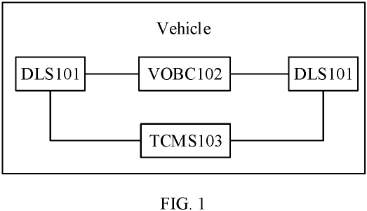

Firstly, an implementation environment of the present disclosure is introduced. FIG. 1 is a structural block diagram of a vehicle according to an embodiment of the present disclosure. As shown in FIG. 1, the vehicle includes two direct location systems (DLS) 101, a vehicle on-board controller (VOBC) 102, and a train control and management system (TCMS) 103. In an embodiment, one of the two DLS may be arranged in the front of the vehicle and the other one may be arranged in the rear of the vehicle. In this way, the DLS at the rear of the preceding vehicle can communicate with the DLS at the front of the rear vehicle, to respectively transmit the vehicle state information of both vehicles to each other.

Moreover, the VOBC102 and the TCMS103 are connected to the DLS101. The VOBC102 is configured to acquire the vehicle state information such as the current position information of the vehicle (e.g., identifier information of a current driving section or a station platform), a current vehicle speed, an acceleration, a relative distance between the vehicle and the preceding vehicle, and transmit the vehicle state information to the DLS101 of the vehicle. The DLS101 is configured to transmit the vehicle state information to other vehicles or servers (such as a cloud control center). The DLS101 can directly receive the vehicle state information transmitted by the other vehicles, or can also receive the vehicle state information transmitted by the servers of other vehicles. The TCMS103 is configured to control the operation of the vehicle according to the vehicle state information of the vehicle and the vehicle state information of the preceding vehicle, so that the vehicle and the preceding vehicle synchronously operate and maintain a stable inter-vehicle distance.

Based on the vehicle structure shown in FIG. 1, the method for controlling the vehicle provided in the present disclosure can be implemented. A premise for implementing the method includes that an effective communication of the DLS of the first vehicle and the second vehicle (that is, the preceding and rear vehicles) have been established. A system positioning function of each vehicle is normal, and the preceding and rear vehicles have an independent load compensation function, which can be realized jointly by the DLS and the TCMS. The load compensation function refers to the adaptive adjustment ability of a torque or a force of the preceding and rear vehicles to ensure the same acceleration and deceleration of the preceding and rear vehicles with different loads.

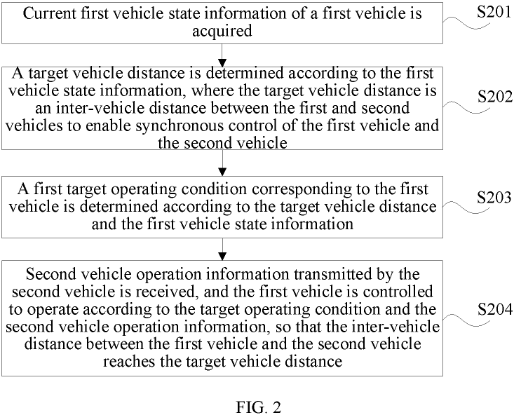

FIG. 2 is a flowchart of a vehicle control method according to an embodiment of the present disclosure. The method is applied to the first vehicle, as shown in FIG. 2. The method includes the following steps.

In step S201, current first vehicle state information of the first vehicle is acquired.

As mentioned above, the present disclosure may be applied to a scenario of synchronous control of the vehicle within the coupling after coupling of the vehicle (such as a rail train). However, the vehicles in the same coupling generally include at least two vehicles, and the vehicles in the same coupling also operate in a same direction. Therefore, the first vehicle may be the rear vehicle of any two adjacent vehicles in the same coupling (that is, the first vehicle and the second vehicle in the present disclosure), and the second vehicle may be the preceding vehicle of the first vehicle in the same coupling. Moreover, the first vehicle may also be a separate vehicle (e.g., a vehicle not coupled with other vehicles). In this case, the first vehicle is the rear vehicle of any two adjacent vehicles driving in a same direction, and the second vehicle is the preceding vehicle of any two adjacent vehicles driving in a same direction.

Moreover, the first vehicle state information may include a current position of the first vehicle, a communication period between the first vehicle and the second vehicle, an actual inter-vehicle distance between the first vehicle and the second vehicle, and the like. In an actual application scenario, when the first vehicle and the second vehicle start a virtual coupling, a communication connection is established between the two vehicles. In an embodiment, the two vehicles can communicate with each other through two parallel channels, that is, the DLS of the first vehicle communicates with the DLS of the second vehicle, and the VOBC of the first vehicle communicates with the VOBC of the second vehicle. Therefore, the communication period includes a communication period between the DLS of the first vehicle and the DLS of the second vehicle, and the communication period between the VOBC of the first vehicle and the VOBC of the second vehicle.

In an embodiment, the current vehicle state information of the first vehicle can be acquired through the VOBC arranged on the first vehicle during the operation of the vehicle.

In step S202, a target vehicle distance is determined according to the first vehicle state information, where the target vehicle distance is an inter-vehicle distance between the first and second vehicles to enable synchronous control of the first vehicle and the second vehicle.

In an actual application scenario, the vehicle control method in the present disclosure may be divided into the synchronous control for operating in the section, the synchronous control for departure from the station platform, and the synchronous control for stopping at the station platform according to a different area and a motion state of the vehicle. It may be understood that when the areas and the motion states of the vehicle are different, the inter-vehicle distances (that is, the target vehicle distances) to be maintained are also different during the synchronous control. Therefore, in this step, the current area of the first vehicle and whether the current state of the vehicle is operating in the section, departing from the station platform, or stopping at the station platform may be determined according to the vehicle state information. Afterwards, a corresponding minimum vehicle distance is determined according to the current area and the current state of the vehicle. The minimum vehicle distance is a minimum vehicle distance that prevents the first vehicle from colliding with the second vehicle. In this way, the target vehicle distance may be set to a distance value greater than or equal to that minimum vehicle distance.

In step S203, a first target operating condition corresponding to the first vehicle is determined according to the target vehicle distance and the first vehicle state information.

The target operating condition may include an operating condition of shortening the vehicle distance, an operating condition of maintaining the vehicle distance, an operating condition of expanding the vehicle distance, or an emergency operating condition.

In an embodiment, the target operating condition can be determined according to the target vehicle distance and the actual inter-vehicle distance between the first vehicle and the second vehicle included in the vehicle state information. For example, if the actual inter-vehicle distance is greater than the target vehicle distance, it is determined that the target operating condition is the operating condition of shortening the vehicle distance. If the actual inter-vehicle distance is less than the target vehicle distance, it is determined that the target operating condition is the operating condition of expanding the vehicle distance. If the actual inter-vehicle distance is equal to the target vehicle distance, it is determined that the target operating condition is the operating condition of maintaining the vehicle distance. The above are only some examples for description and do not limit the present disclosure.

In step S204, second vehicle operation information transmitted by the second vehicle is revived, and the first vehicle is controlled to operate according to the target operating condition and the second vehicle operation information, so that the inter-vehicle distance between the first vehicle and the second vehicle may reach the target vehicle distance.

In the above method, the first vehicle and the second vehicle maintain a good stable interval during the operation of the current target operating condition, that is, the target vehicle distance, and the precision of vehicle synchronous control is improved.

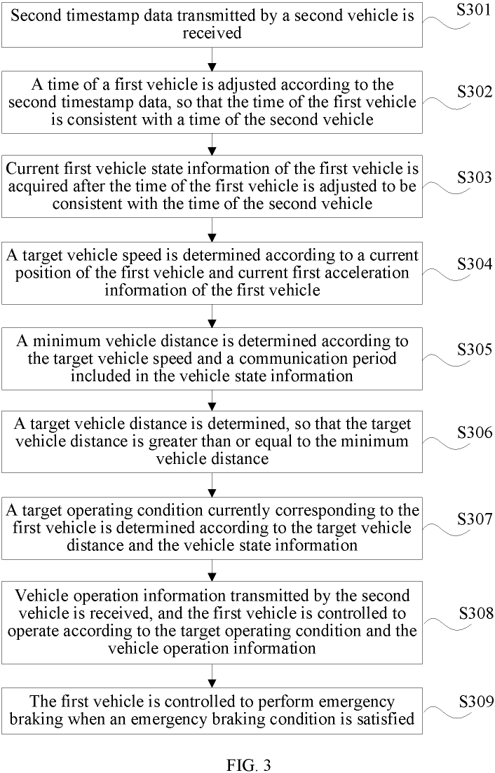

FIG. 3 is a flowchart of a vehicle control method according to an embodiment of the present disclosure. The method can be applied to the first vehicle. The present disclosure may be applied to a scenario of the synchronous control of the coupled vehicles (such as a rail train). However, the vehicles in the same coupling generally include at least two vehicles, and the vehicles in the same coupling also operate in a same direction. Therefore, the first vehicle may be the rear vehicle of any two adjacent vehicles in the same coupling (that is, the first vehicle and the second vehicle in the present disclosure), and the second vehicle is the preceding vehicle of the first vehicle in the same coupling. In the embodiment shown in FIG. 3, the first vehicle is the rear vehicle and the second vehicle is the preceding vehicle. As shown in FIG. 3, the method includes the following steps.

In step S301, second timestamp data transmitted by the second vehicle is received.

In order to ensure the control accuracy of the synchronous control of the first vehicle and the second vehicle, the time of the two vehicles can be controlled synchronously after the DLS between the two vehicles are connected. In this embodiment, the time of the first vehicle can be controlled to be consistent with the time of the second vehicle by performing steps S301 to S302. In an embodiment, the first vehicle and the second vehicle can verify and compare the time by transmitting the timestamp data to each other. The timestamp data may include the current vehicle time of the second vehicle.

In step S302, a time of the first vehicle is adjusted according to the second timestamp data, so that the time of the first vehicle is consistent with the time of the second vehicle.

In the present disclosure, the traction force or the braking force during the operation of the first vehicle (that is, the rear vehicle) is adjusted according to the received second vehicle operation information (such as the vehicle acceleration information) of the second vehicle (that is, the preceding vehicle), so as to ensure that a target vehicle distance between the first vehicle and the second vehicle is maintained for the operation. Therefore, if clocks of the first vehicle and the second vehicle are inconsistent, the clock of the second vehicle is used as a reference for calibration, so that the times of the first vehicle and the second vehicle are consistent, and the time synchronization accuracy needs to reach the millisecond level. It should be noted that the DLS and the VOBC of the two vehicles both need to perform the clock synchronization during the clock synchronization process on the first vehicle and the second vehicle, to ensure the time consistency during the multichannel communication.

In this step, the times of the DLS and the TCMS of the first vehicle may be adjusted according to the timestamp data, so that the time of the DLS of the first vehicle is consistent with the time of the DLS of the second vehicle, and the time of the TCMS of the first vehicle is consistent with the time of the TCMS of the second vehicle. When the DLS of the first vehicle completes the time synchronization with the DLS of the second vehicle, period synchronization may be performed in a TCMS network of the first vehicle, so that a starting point of a control period of all devices in the TCMS network can be adjusted synchronously with the DLS, thereby achieving a higher control accuracy.

In step S303, current first vehicle state information of the first vehicle is acquired after the time of the first vehicle is adjusted to be consistent with the time of the second vehicle.

The vehicle state information may include a current position of the first vehicle, current first acceleration information of the first vehicle, a communication period between the first vehicle and the second vehicle, an actual inter-vehicle distance between the first vehicle and the second vehicle, and the like. Moreover, when the first vehicle and the second vehicle start a virtual coupling, a communication connection is established between the two vehicles. In an embodiment, two vehicles can communicate with each other through two parallel channels, that is, the DLS of the first vehicle communicate with the DLS of the second vehicle, and the VOBC of the first vehicle communicates with the VOBC of the second vehicle. Therefore, the communication period includes the communication period between the DLS of the first vehicle and the DLS of the second vehicle, and the communication period between the VOBC of the first vehicle and the VOBC of the second vehicle.

In an embodiment, the current first vehicle state information of the first vehicle can be acquired through the VOBC arranged on the first vehicle during the operation of the vehicle.

After acquiring the first vehicle state information, the target vehicle distance can be determined by performing steps S304 to S306 according to the vehicle state information. The target vehicle distance is an inter-vehicle distance to be maintained during the synchronous control of the first vehicle and a second vehicle.

In step S304, a target vehicle speed is determined according to the current position of the first vehicle and the current first acceleration information of the first vehicle.

The target vehicle speed may include a maximum speed limit of a line corresponding to the area where the vehicle is currently located. In an actual application scenario, the vehicle control method in the present disclosure may be divided into the synchronous control for operating in the section, the synchronous control for departure from the station platform, and the synchronous control for stopping at the station platform according to a different area and a motion state of the vehicle. It may be understood that in a case that the areas and the motion states of the vehicle are different, the inter-vehicle distances (that is, the target vehicle distance) to be maintained are also different during the synchronous control, and the corresponding target vehicle speed of the vehicle is also different.

In this step, a current area of the first vehicle may be determined according to the current position of the first vehicle. The area may include an operating section or a station platform. Then, an operating state of the first vehicle is determined according to the current area of the first vehicle and the first acceleration information. The operating state includes operating in the section, departing from the station platform, or stopping at the station platform, to determine the target vehicle speed according to the operating state.

The operating section may be an operation line between two station platforms. When it is determined, according to the current position of the first vehicle, that the vehicle is currently at the station platform, the first vehicle is stopping at the station platform if the speed of the first vehicle gradually decreases, or the first vehicle is departing from the station platform if the speed of the first vehicle gradually increases. Therefore, when it is determined that the vehicle is located at the station platform, it may be further determined, according to the current first acceleration information of the first vehicle, whether the vehicle is stopping at the station platform or departing from the station platform. In this way, the maximum speed limit of the current route of the first vehicle may be used as the target vehicle speed when the vehicle is operating in the section or departing from the station platform. When the vehicle stops at the station platform, an average speed of the first vehicle in a preset historical time period may be used as the target vehicle speed. An end moment of the preset historical time period is the current moment.

It may be understood that, when it is determined that the vehicle is located at the station platform, it is determined that the first vehicle is decelerating if the first acceleration is less than 0, which indicates that the first vehicle is stopping at the station platform. If the first acceleration is greater than 0, it is determined that the first vehicle is currently accelerating, which indicates that the first vehicle is departing from the station platform.

In step S305, a minimum vehicle distance is determined according to the target vehicle speed and communication period included in the vehicle state information.

The minimum vehicle distance is a minimum vehicle distance that prevents the first vehicle from colliding with the second vehicle.

In an embodiment, the minimum vehicle distance may be calculated by using the following formula:

$${D}_{min} = V * \left({T}_{v o b c} - {T}_{d l s}\right) ,$$

where Dₘᵢₙ represents the minimum vehicle distance, V represents the target vehicle speed, T_{vobc} represents the communication period between the VOBC of the first vehicle and the VOBC of the second vehicle, and T_{dls} represents the communication period between the DLS of the first vehicle and the DLS of the second vehicle.

In step S306, a target vehicle distance is determined, so that the target vehicle distance is greater than or equal to the minimum vehicle distance.

The target vehicle distance is an inter-vehicle distance that needs to be maintained during the synchronous control of the first vehicle and the second vehicle. The target vehicle distance may be set to any distance value greater than or equal to the minimum vehicle distance according to an actual requirement, which is not limited in the present disclosure.

In step S307, a target operating condition currently corresponding to the first vehicle is determined according to the target vehicle distance and the first vehicle state information.

Considering the actual application scenario, the synchronous control of vehicle includes the following four operating conditions: an operating condition of shortening the vehicle distance, an operating condition of maintaining the vehicle distance, an operating condition of expanding the vehicle distance, and an emergency operating condition. Therefore, the target operating condition includes any of the above operating conditions. The vehicle state information includes an actual inter-vehicle distance between the first vehicle and the second vehicle. The actual inter-vehicle distance may be collected by the DLS arranged on the first vehicle, or may be the received actual inter-vehicle distance collected by the DLS of the second vehicle and transmitted by the second vehicle.

The vehicle synchronous control method provided by the present disclosure shall maintain the target vehicle distance when synchronizing the first vehicle and the second vehicle. Therefore, if the actual inter-vehicle distance is greater than the target vehicle distance, it is determined that the target operating condition is the operating condition of shortening the vehicle distance. If the actual inter-vehicle distance is less than the target vehicle distance, it is determined that the target operating condition is the operating condition of expanding the vehicle distance. If the actual inter-vehicle distance is equal to the target vehicle distance, it is determined that the target operating condition is the operating condition of maintaining the vehicle distance.

Moreover, the target operating condition may further include the emergency operating condition. In this way, it is determined that the target operating condition is the operating condition of expanding the vehicle distance if the actual inter-vehicle distance is less than the target vehicle distance and greater than or equal to the minimum vehicle distance. If the actual inter-vehicle distance is less than the minimum vehicle distance, it is determined that the target operating condition is the emergency operating condition.

It should be noted that, in the actual application scenario, an error of the actual inter-vehicle distance acquired by the DLS is large if the DLS of the vehicle fails. In this case, the current operating condition is inaccurate if the current operating condition of the vehicle is determined based on the actual inter-vehicle distance having the large error. Therefore, in order to determine the current operating condition of the vehicle more accurately, the accuracy of the actual inter-vehicle distance acquired by the first vehicle can further be verified.

The DLS arranged at the front of the first vehicle in the actual application scenario can collect the actual inter-vehicle distance between the first vehicle and the second vehicle D1, the DLS arranged at the rear of the second vehicle can also collect the actual inter-vehicle distance between the first vehicle and the second vehicle D2, and the second vehicle can transmit the collected actual inter-vehicle distance D2 to the first vehicle. Therefore, the first vehicle can calculate a difference between D1 and D2, and, it can be determined that the actual inter-vehicle distance D1 acquired by the first vehicle is more accurate if the difference between D1 and D2 is less than or equal to a preset distance threshold (the preset distance threshold may be 0 or a smaller value). Otherwise, the DLS arranged at the front of the first vehicle may be regarded as faulty, and the current operating condition of the vehicle cannot be accurately determined.

In step S308, second vehicle operation information transmitted by the second vehicle is received, and the first vehicle is controlled to operate according to the first target operating condition and the second vehicle operation information.

The second vehicle operation information may include the current second acceleration information of the second vehicle.

In this step, it can be determined that the current actual inter-vehicle distance of the first vehicle is equal to the target vehicle distance, when the target operating condition is the operating condition of maintaining the vehicle distance. In this case, the first vehicle may be controlled to operate in accordance with the second acceleration information of the second vehicle, in order to maintain the target vehicle distance between the first vehicle and the second vehicle. That is to say, if the second vehicle accelerates, the first vehicle accelerates at the same acceleration. If the second vehicle decelerates, the first vehicle decelerates at the same acceleration. If the second vehicle is at a constant speed, the first vehicle drives at a same constant speed (that is, the second acceleration is 0), which is not limited in the present disclosure.

In the process of controlling the first vehicle to operate according to the second acceleration information of the second vehicle, the TCMS of the first vehicle can calculate the corresponding traction force or braking force according to the vehicle load information of the first vehicle, to control the operation of the first vehicle according to the traction force or the braking force.

It should be noted that, when the vehicle is in the operating condition of maintaining the vehicle distance, a change of the actual inter-vehicle distance between the first vehicle and the second vehicle requires to be monitored in real time, and a synchronous controller is configured to fine-tune the traction force or the braking force. The synchronous controller may be a proportional-integral-derivative (PID) controller or a fuzzy controller.

Moreover, a target traction force corresponding to the first vehicle is determined according to the second acceleration information of the second vehicle and the current first acceleration information of the first vehicle. When the target operating condition is the operating condition of shortening the vehicle distance, the first vehicle is controlled to operate according to the target traction force, to shorten the actual inter-vehicle distance to the target vehicle distance.

In the case that the vehicle is in the operating condition of shortening the vehicle distance, the first vehicle may accelerate with an acceleration greater than that of the second vehicle to shorten the actual inter-vehicle distance to the target vehicle distance. Therefore, after receiving the second acceleration information transmitted by the second vehicle, the first vehicle can calculate the acceleration difference between the two vehicles according to the second acceleration information of the second vehicle and the current first acceleration information of the first vehicle, and then determine additional acceleration information according to the acceleration difference. The additional acceleration information indicates an acceleration increase of the first vehicle. It may be understood that the acceleration increase is greater than the acceleration difference, to shorten the actual inter-vehicle distance to the target vehicle distance. In this way, the DLS of the first vehicle can transmit the additional acceleration information to the TCMS of the first vehicle, which converts the additional acceleration information and the current vehicle load information into the target traction force.

In an embodiment, assuming that the second acceleration information transmitted by the second vehicle is a1 and the current first acceleration information of the first vehicle is a2, the additional acceleration information a corresponding to the first vehicle can be determined according to the second acceleration information a1 and the first acceleration information a2, where a ≥ (a1 - a2). The first vehicle can determine the traction force increase ΔF1 based on the additional acceleration information a and the current vehicle load information, and then calculate a sum of the traction force increase ΔF1 and the current traction force of the first vehicle to obtain the target traction force F1, to control the first vehicle to operate according to the target traction force F1 and to shorten the actual inter-vehicle distance to the target vehicle distance. This is only an example for description and is not limited in the present disclosure.

In an embodiment, a target control force corresponding to the first vehicle may be determined according to the second acceleration information of the second vehicle and the current first acceleration information of the first vehicle. The target control force includes a traction force or a braking force. When the target operating condition is the operating condition of expanding the vehicle distance or the emergency operating condition, the first vehicle is controlled to operate according to the target control force to expand the actual inter-vehicle distance to the target vehicle distance.

In the case that the vehicle is in the operating condition of expanding the vehicle distance or the emergency operating condition, the first vehicle can expand the actual inter-vehicle distance to the target vehicle distance by reducing the vehicle speed. The first vehicle can reduce the vehicle speed by applying the braking force or by shifting a current gear of the first vehicle to a lower gear. Therefore, after receiving the second acceleration information transmitted by the second vehicle, the first vehicle can calculate the acceleration difference between the two vehicles according to the second acceleration information of the second vehicle and the current first acceleration information of the first vehicle, and then determine additional acceleration information according to the acceleration difference. The additional acceleration information indicates an acceleration reduction of the first vehicle. It may be understood that the acceleration reduction is greater than the acceleration difference, to expand the actual inter-vehicle distance to the target vehicle distance. In this way, the DLS of the first vehicle can transmit the additional acceleration information to the TCMS of the first vehicle, which converts the additional acceleration information and the current vehicle load information into the target control force (that is, the target traction force or the target braking force).

In an embodiment, assuming that the second acceleration information transmitted by the second vehicle is a1 and the current first acceleration information of the first vehicle is a2, the additional acceleration information a corresponding to the first vehicle can be determined according to the second acceleration information a1 and the first acceleration information a2, where a ≥ (a1 - a2). The first vehicle can determine the traction force reduction ΔF2 based on the additional acceleration information a and the current vehicle load information, and then calculate a difference of the traction force increase ΔF2 and the current traction force of the first vehicle to obtain the target traction force F2. The target traction force F2 is less than the current traction force of the first vehicle, so the first vehicle is controlled to operate according to the target traction force F2, and then the vehicle speed of the first vehicle is reduced, to expand the actual inter-vehicle distance to the target vehicle distance. Or, the first vehicle can determine a target braking force F3 according to the additional acceleration information a and the current vehicle load information, apply the target braking force F3 to the first vehicle, and then reduce the vehicle speed of the first vehicle to achieve an expansion of the actual inter-vehicle distance to the target vehicle distance. This is only an example for description and is not limited in the present disclosure.

It also should be noted that in the case that the vehicle is in the operating condition of shortening the vehicle distance, the operating condition of expanding the vehicle distance, or the emergency operating condition, the current operating condition may be exited and the operating condition of maintaining the vehicle distance may be entered when the actual inter-vehicle distance of the vehicle reaches the target distance, so as to control the first vehicle and the second vehicle to maintain the target vehicle distance.

Step S309: The first vehicle is controlled to perform emergency braking when an emergency braking condition is met.

The emergency braking condition includes receipt of an emergency braking instruction transmitted by the second vehicle, or determination of an abnormal communication between the first vehicle and the second vehicle.

In a case that the emergency braking instruction transmitted by the second vehicle is received, it is determined that the second vehicle is currently performing the emergency braking. In this case, in order to avoid a collision with the second vehicle, the first vehicle needs to be controlled to perform the emergency braking. In addition, considering that the synchronous control method provided in the present disclosure is synchronously controlling the first vehicle according to the vehicle operation information transmitted by the second vehicle, the first vehicle may also be controlled to perform the emergency braking in order to avoid a collision with the second vehicle, if the communication between the second vehicle and the first vehicle fails (that is, the first vehicle cannot be synchronously controlled according to the vehicle operation information of the second vehicle).

Moreover, in order to improve the safety of the vehicles during the synchronous control of the vehicles, two parallel channels may be used to transmit the emergency braking instruction in the present disclosure. In an embodiment, the first vehicle may receive the emergency braking instructions transmitted by the DLS and the VOBC of the second vehicle, and a transmission delay of the DLS is less than a transmission delay of the VOBC. When the DLS of the first vehicle receives the emergency braking instruction of the second vehicle, the instruction may be synchronously transmitted to the VOBC of the first vehicle. The VOBC of the first vehicle may use the emergency braking instruction of the DLS as an externally given emergency braking instruction in a synchronous control mode, thereby applying the emergency braking. If the DLS of the first vehicle fails to receive the emergency braking instruction transmitted by the second vehicle, and the VOBC of the first vehicle receives the emergency braking instruction transmitted by the VOBC of the second vehicle, the second vehicle normally applies the emergency braking. If the communication between the DLS and the VOBC of the first vehicle and the DLS and the VOBC of the second vehicle are interrupted, it is determined that the communication between the vehicles is abnormal. In this case, a brake may be applied at the maximum acceleration, thereby avoiding the collision between the first vehicle and the second vehicle as much as possible.

By using the above method, the time synchronization may be performed on the first vehicle and the second vehicle, and different control strategies may be adopted to control the synchronous operation of the vehicles according to different operating conditions, so that the inter-vehicle distance between the preceding vehicle and the rear vehicle is maintained at the target vehicle distance. In this way, the vehicle can obtain desirable synchronous control precision in different scenarios, and a safe response distance can be provided for a possible device failure or communication failure, thereby improving the safety of vehicle synchronous control.

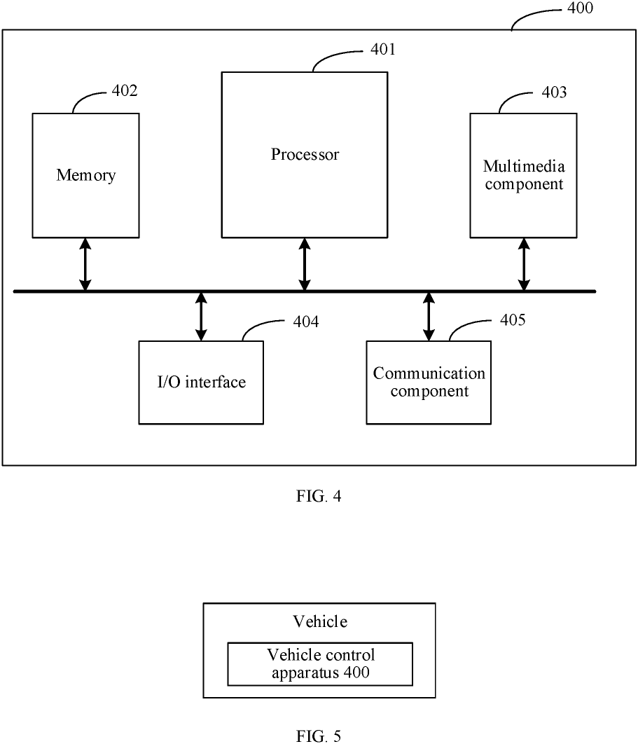

FIG. 4 is a block diagram of a vehicle control apparatus 400 according to an embodiment of the present disclosure. As shown in FIG. 4, the vehicle control apparatus 400 may include a processor 401 and a memory 402. The vehicle control apparatus 400 may further include one or more of a multimedia component 403, an input/output (I/O) interface 404, and a communication component 405.

The processor 401 is configured to control the overall operation of the vehicle control apparatus 400 to complete all or some steps in the foregoing method for controlling the vehicle. The memory 402 is configured to store various types of data to support operations on the vehicle control apparatus 400. Such data may include, for example, an instruction for any application or method operated on the vehicle control apparatus 400, and application-related data, such as contact data, sent and received messages, pictures, audio, and video, and so on. The memory 402 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read only memory (ROM), a magnetic memory, a flash memory, and a disk or an optical disk. The multimedia component 403 may include a screen and an audio component. The screen may be, for example, a touch screen, and the audio component is configured to output and/or input an audio signal. For example, the audio component may include a microphone for receiving an external audio signal. The received audio signal may be further stored in the memory 402 or sent through the communication component 405. The audio component further includes at least one speaker for outputting the audio signal. The I/O interface 404 provides an interface between the processor 401 and other interface modules. The foregoing interface modules may be a keyboard, a mouse, or a button, etc.. The buttons may be virtual buttons or physical buttons. The communication component 405 is configured to perform wired or wireless communication between the vehicle control apparatus 400 and other terminal devices. The wireless communication may include, for example, a Wi-Fi, a Bluetooth, a Near Field Communication (NFC), 2G, 3G, 4G, NB-IOT, eMTC, or other 5G, or one or a combination of the above, which is not limited herein. Therefore, the corresponding communication component 405 may include a Wi-Fi module, a Bluetooth module, an NFC module, and so on.

In an embodiment, the vehicle control apparatus 400 may be implemented by one or more of application specific integrated circuits (ASIC), a digital signal processor (DSP), a digital signal processing device (DSPD), a programmable logic device (PLD), a field programmable gate arrays (FPGA), a controller, a microcontroller, a microprocessor, or other electronic elements, for performing the foregoing vehicle control method.

The current vehicle state information of the first vehicle can be acquired by using the above apparatus, and then a target vehicle distance to be maintained during the synchronous control of the first vehicle and the second vehicle is determined according to the vehicle state information. A target operating condition corresponding to the first vehicle is determined according to the target vehicle distance and vehicle state information, and the received vehicle operation information transmitted by the second vehicle, to control the operation of the first vehicle according to the target operating condition corresponding to the first vehicle and the vehicle operation information of the second vehicle, to ensure that the first vehicle and the second vehicle maintain a good stable interval (that is, the target vehicle distance) during the operation of the current target operating condition, and to improve the precision of vehicle synchronous control.

In another embodiment, a computer-readable storage medium (e.g., a non-transitory computer-readable storage medium) storing a computer program is further provided. When the computer program is executed by the processor, the steps of the above vehicle control method are performed.

FIG. 5 is a structural block diagram of a vehicle according to an embodiment of the present disclosure. As shown in FIG. 5, the vehicle includes the vehicle control apparatus described above.

The implementations of the present disclosure are described in detail above with reference to the accompanying drawings. However, the present disclosure is not limited to the details in the foregoing implementations, changes may be made to the technical solution of the present disclosure within a range of the technical concept of the present disclosure, and these changes fall within the protection scope of the present disclosure.

In addition, it should be noted that the specific technical features described in the foregoing implementations may be combined in any manner with no contradiction. In order to avoid unnecessary repetition, various possible combinations are not described separately in the present disclosure.

In addition, various different implementations of the present disclosure may also be combined without departing from the idea of the present disclosure, and the combinations shall still be regarded as the content disclosed in the present disclosure.

What is claimed is:

1. A method for controlling a vehicle, comprising:
acquiring current first vehicle state information of a first vehicle;
determining a target vehicle distance according to the current first vehicle state information, wherein the target vehicle distance comprises an inter-vehicle distance between the first vehicle and a second vehicle to enable synchronous control of the first vehicle and the second vehicle;
determining a first target operating condition corresponding to the first vehicle according to the target vehicle distance and the current first vehicle state information; and
receiving second vehicle operation information transmitted by the second vehicle, and adjusting the inter-vehicle distance to the target vehicle distance by controlling an operation of the first vehicle according to the first target operating condition and the second vehicle operation information.

2. The method according to claim 1, wherein
the determining a target vehicle distance according to the current first vehicle state information comprises determining a minimum vehicle distance according to the current first vehicle state information, and the minimum vehicle distance is a minimum distance between the first vehicle and the second vehicle that prevents the first vehicle from colliding with the second vehicle; and
the target vehicle distance is greater than or equal to the minimum vehicle distance.

3. The method according to claim 2, wherein
the current first vehicle state information comprises a current first position of the first vehicle, current first acceleration information of the first vehicle, and a communication period between the first vehicle and the second vehicle; and
the determining a minimum vehicle distance according to the current first vehicle state information comprises:
determining a target first vehicle speed according to the current first position of the first vehicle and the current first acceleration information of the first vehicle; and
determining the minimum vehicle distance according to the target first vehicle speed and the communication period.

4. The method according to claim 3, wherein the determining a target first vehicle speed according to the current first position of the first vehicle and the current first acceleration information of the first vehicle comprises:
determining a current first area of the first vehicle according to the current first position of the first vehicle, wherein the current first area comprises an operating section or a station platform;
determining a first operating state of the first vehicle according to the current first area of the first vehicle and the current first acceleration information of the first vehicle, wherein the first operating state comprises operating in the operating section, departing from the station platform, or stopping at the station platform; and
determining the target first vehicle speed according to the first operating state.

5. The method according to claim 1, wherein
the first target operating condition comprises: shortening the inter-vehicle distance, expanding the inter-vehicle distance, or maintaining the inter-vehicle distance;
the current first vehicle state information comprises an actual inter-vehicle distance between the first vehicle and the second vehicle; and
the determining a first target operating condition corresponding to the first vehicle according to the target vehicle distance and the current first vehicle state information comprises:
in response to that the actual inter-vehicle distance is greater than the target vehicle distance, determining the shortening the inter-vehicle distance as the first target operating condition;
in response to that the actual inter-vehicle distance is less than the target vehicle distance, determining the expanding the inter-vehicle distance as the first target operating condition; and
in response to that the actual inter-vehicle distance is equal to the target vehicle distance, determining the maintaining the inter-vehicle distance as the first target operating condition.

6. The method according to claim 5, further comprising:
in response to that the actual inter-vehicle distance is less than the target vehicle distance and greater than or equal to the minimum vehicle distance, determining the expanding the vehicle distance as the first target operating condition.

7. The method according to claim 5, wherein the first target operating condition comprises an emergency operating condition, and the method further comprises:
in response to that the actual inter-vehicle distance is less than the minimum vehicle distance, determining the emergency operating condition as the first target operating condition.

8. The method according to claim 5, wherein
the second vehicle operation information comprises current second acceleration information of the second vehicle; and
the adjusting the inter-vehicle distance to the target vehicle distance by controlling an operation of the first vehicle according to the first target operating condition and the second vehicle operation information comprises:
in response to that the first target operating condition is the shortening the inter-vehicle distance, determining a first target traction force corresponding to the first vehicle according to the current second acceleration information of the second vehicle and the current first acceleration information of the first vehicle, and shortening the actual inter-vehicle distance to the target vehicle distance by controlling the first vehicle to operate according to the first target traction force; or
in response to that the first target operating condition is the expanding the inter-vehicle distance or the emergency operating condition, determining a first target control force corresponding to the first vehicle according to the current second acceleration information and the current first acceleration information of the first vehicle, and expanding the actual inter-vehicle distance to the target vehicle distance by controlling the first vehicle to operate according to the first target control force, wherein the first target control force comprises a traction force or a braking force; or
in response to that the first target operating condition is the maintaining the inter-vehicle distance, maintaining the actual inter-vehicle distance at the target vehicle distance by controlling the first vehicle to operate according to the current second acceleration information.

9. The method according to claim 1, further comprising:
in response to that an emergency braking instruction transmitted by the second vehicle is received, controlling the first vehicle to perform emergency braking; or
in response to determining that a communication between the first vehicle and the second vehicle is abnormal, controlling the first vehicle to perform emergency braking.

10. The method according to claim 1, further comprising:
receiving second timestamp data transmitted by the second vehicle;
adjusting a first time of the first vehicle according to the second timestamp data, wherein the adjusted first time of the first vehicle is consistent with a second time of the second vehicle; and the acquiring current first vehicle state information of a first vehicle comprises:
acquiring the current first vehicle state information when the adjusted first time of the first vehicle is consistent with the second time of the second vehicle.

11. The method according to claim 10, wherein the adjusting a first time of the first vehicle according to the second timestamp data comprises:
adjusting a first time of a direct positioning system (DLS) of the first vehicle and a first time of a train control and management system (TCMS) of the first vehicle according to the second timestamp data, wherein the adjusted first time of the DLS of the first vehicle is consistent with a second time of a DLS of the second vehicle, and the adjusted first time of the TCMS of the first vehicle is consistent with a second time of a TCMS of the second vehicle.

12. An apparatus for controlling a vehicle, comprising:
a memory storing a computer program; and
a processor, configured to execute the computer program to perform operations comprising:
acquiring current first vehicle state information of a first vehicle;
determining a target vehicle distance according to the current first vehicle state information, wherein the target vehicle distance comprises an inter-vehicle distance between the first vehicle and a second vehicle to enable synchronous control of the first vehicle and the second vehicle;
determining a first target operating condition corresponding to the first vehicle according to the target vehicle distance and the current first vehicle state information; and
receiving second vehicle operation information transmitted by the second vehicle, and adjusting the inter-vehicle distance to the target vehicle distance by controlling an operation of the first vehicle according to the first target operating condition and the second vehicle operation information.

13. The apparatus according to claim 12, wherein
the determining a target vehicle distance according to the current first vehicle state information comprises determining a minimum vehicle distance according to the current first vehicle state information, and the minimum vehicle distance is a minimum distance between the first vehicle and the second vehicle that prevents the first vehicle from colliding with the second vehicle; and
the target vehicle distance is greater than or equal to the minimum vehicle distance.

14. The apparatus according to claim 13, wherein
the current first vehicle state information comprises a current first position of the first vehicle, current first acceleration information of the first vehicle, and a communication period between the first vehicle and the second vehicle; and
the determining a minimum vehicle distance according to the current first vehicle state information comprises:
determining a target first vehicle speed according to the current first position of the first vehicle and the current first acceleration information of the first vehicle; and
determining the minimum vehicle distance according to the target first vehicle speed and the communication period.

15. The apparatus according to claim 12, wherein
the first target operating condition comprises: shortening the inter-vehicle distance, expanding the inter-vehicle distance, or maintaining the inter-vehicle distance;
the current first vehicle state information comprises an actual inter-vehicle distance between the first vehicle and the second vehicle; and
the determining a first target operating condition corresponding to the first vehicle according to the target vehicle distance and the current first vehicle state information comprises:
in response to that the actual inter-vehicle distance is greater than the target vehicle distance, determining the shortening the inter-vehicle distance as the first target operating condition;
in response to that the actual inter-vehicle distance is less than the target vehicle distance, determining the expanding the inter-vehicle distance as the first target operating condition; and
in response to that the actual inter-vehicle distance is equal to the target vehicle distance, determining the maintaining the inter-vehicle distance as the first target operating condition.

16. The apparatus according to claim 15, wherein the first target operating condition comprises an emergency operating condition, and the method further comprises:
in response to that the actual inter-vehicle distance is less than the minimum vehicle distance, determining the emergency operating condition as the first target operating condition.

17. The apparatus according to claim 15, wherein
the second vehicle operation information comprises current second acceleration information of the second vehicle; and
the adjusting the inter-vehicle distance to the target vehicle distance by controlling an operation of the first vehicle according to the first target operating condition and the second vehicle operation information comprises:
in response to that the first target operating condition is the shortening the inter-vehicle distance, determining a first target traction force corresponding to the first vehicle according to the current second acceleration information of the second vehicle and the current first acceleration information of the first vehicle, and shortening the actual inter-vehicle distance to the target vehicle distance by controlling the first vehicle to operate according to the first target traction force; or
in response to that the first target operating condition is the expanding the inter-vehicle distance or the emergency operating condition, determining a first target control force corresponding to the first vehicle according to the current second acceleration information and the current first acceleration information of the first vehicle, and expanding the actual inter-vehicle distance to the target vehicle distance by controlling the first vehicle to operate according to the first target control force, wherein the first target control force comprises a traction force or a braking force; or
in response to that the first target operating condition is the maintaining the inter-vehicle distance, maintaining the actual inter-vehicle distance at the target vehicle distance by controlling the first vehicle to operate according to the current second acceleration information.

18. The apparatus according to claim 12, wherein the operations further comprises:
receiving second timestamp data transmitted by the second vehicle;
adjusting a first time of the first vehicle according to the second timestamp data, wherein the adjusted first time of the first vehicle is consistent with a second time of the second vehicle; and
the acquiring current first vehicle state information of a first vehicle comprises:
acquiring the current first vehicle state information when the adjusted first time of the first vehicle is consistent with the second time of the second vehicle.

19. A non-transitory computer-readable storage medium, storing a computer program, wherein when the computer program is executed by a processor, causes the processor to perform operations comprising:
acquiring current first vehicle state information of a first vehicle;
determining a target vehicle distance according to the current first vehicle state information, wherein the target vehicle distance comprises an inter-vehicle distance between the first vehicle and a second vehicle;
determining a first target operating condition corresponding to the first vehicle according to the target vehicle distance and the current first vehicle state information; and
receiving second vehicle operation information transmitted by the second vehicle, and adjusting the inter-vehicle distance to the target vehicle distance by controlling an operation of the first vehicle according to the first target operating condition and the second vehicle operation information.

20. A vehicle, comprising the apparatus for controlling a vehicle according to claim 12.
